(19) United States
(12) Patent Application Publication
(10) Pub. No.: US 2007/0005234 A1
(43) Pub. Date: Jan. 4, 2007

(54) Image Requesting Apparatus and Recorder System

(75) Inventors: Susumu Kashiwase, Kanagawa (JP); Takashi Matsumura, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION

(21) Appl. No.: 11/427,271

(22) Filed: Jun. 28, 2006

(30) Foreign Application Priority Data
Jun. 29, 2005 (JP) P.2005-190630

(51) Int. Cl. G01C 21/00

(52) U.S. Cl. 701/200

(57) ABSTRACT

When a vehicle detects that it has been rendered in a prescribed state, the vehicle acquires prescribed state detection position data indicating a position where the vehicle is located when it detects the prescribed state and prescribed state detection time data indicating a time of the detection of the prescribed state. The vehicle sends, to a recording apparatus, a request message that contains the position data and the time data.

### BACKGROUND OF THE INVENTION

The present invention relates to an image transmission requesting apparatus and a recorder system.

In recent years, drive recording apparatus have increasingly come to be installed in movable bodies such as trucks, buses, and taxis. Drive recording apparatus are recording apparatus which are installed in movable bodies and continuously record particular kinds of data. More specifically, a drive recording apparatus continuously records, as service data, position information indicating the position of the movable body in which the apparatus is installed and time information indicating the time. Drive recording apparatus also perform processing to send recorded service data to a data center. A data gathering server which is installed in the data center edits accumulated service data, and edited data are used for recognizing service statuses of movable bodies.

Accident data, as one kind of service data, are data indicating a time, position, etc. of an accident. Upon detecting an accident of the movable body in-which a drive recording apparatus itself is installed, the drive recording apparatus saves accident data and sends this data to the data center (refer to JP-A-2002-42288, for example). There are drive recording apparatus that are equipped with a camera, and accident data recorded and sent by such drive recording apparatus include image information of images taken by the camera at the time of an accident.

However, conventional drive recording apparatus can only detect an accident of a movable body in which the apparatus itself is installed. Therefore, image information of images of an accident that can be acquired by the data gathering server of the data center is limited to information included in accident data that have been sent from the drive recording apparatus installed in the movable body that had the accident. The image information thus acquired may not be sufficient for later recognition of the details of the accident.

### SUMMARY OF THE INVENTION

The present invention has been made to solve the above problem, and one object of the invention is therefore to provide an image requesting apparatus and a recorder system which enable recording apparatus other than the one installed in a movable body that has had an accident to save image information of images of the accident.

To attain the above object, the invention provides an image requesting apparatus, comprising state detecting section for detecting a state of a movable body; position data acquiring section for acquiring position data indicating a position where the movable body is located when the state detecting section detects a prescribed state; time data acquiring section for acquiring time data indicating a time when the state detecting section detects the prescribed state; and request message sending section for sending a request message that contains the position data and the time data to a recording apparatus.

When a certain movable body is rendered in a prescribed state (e.g., has had an accident), the image transmission requesting apparatus having the above configuration can cause recording apparatus to send image information of images taken at the time of the accident. This makes it possible to cause recording apparatus other than the recording apparatus installed in the movable body that has had the accident to send image information of images taken at the time of the accident.

In the above image requesting apparatus, the request message may include the message to save a recording data based on the position data and the time data.

The invention also provides a recorder system comprising plural recording apparatus provided with shooting section and an image transmission requesting apparatus, wherein the image requesting apparatus comprises: state detecting section for detecting a state of a movable body; position data acquiring section for acquiring position data indicating a position where the movable body is located when the state detecting section detects a prescribed state; time data acquiring section for acquiring time data indicating a time when the state detecting section detects the prescribed state; and request message sending section for sending a request message that contains the position data and the time data to a recording apparatus; each of the plural recording apparatus comprises: receiving section for receiving the request message sent from the image requesting apparatus; and saving section for saving image information that was taken by the shooting section when the request message is received by the receiving section.

In the recorder system having the above configuration, in the case where it was detected that a movable body had been rendered in a prescribed state, the image requesting apparatus can store image information that was taken at the time of the detection of the prescribed state.

The above recorder system may be such that the request message includes message to save the image information based on the position data and the time data.

The above recorder system may be such that each of the recording apparatus further comprises image information regularly acquiring section for regularly acquiring image information taken by the shooting section; and wherein the saving section selects, on the basis of the position data and the time data included in the request messages at least one piece of image information from pieces of image information that were taken regularly by the image information regularly acquiring section and saves the selected at least one piece of image information, when the request message is received by the receiving section.

In this recorder system, each recording apparatus can save, from pieces of image information that were acquired regularly, image information that was taken when a prescribed state was detected by a recording apparatus that sends a request message.

### BRIEF DESCRIPTION OF THE DRAWINGS

FIG. 1 shows the configuration of a recorder system 1 according to an embodiment of the present invention;

FIG. 2 shows the system configuration of each vehicle according to the embodiment of the invention;

FIG. 3 is a process flowchart for each vehicle according to the embodiment of the invention;

FIG. 4 is another process flowchart for each vehicle according to the embodiment of the invention;

FIG. 5 illustrates sampling timing correction processing according to the embodiment of the invention;

FIG. 6 is a process flowchart for vehicles according to the embodiment of the invention;

FIG. 7 is a sequence diagram of the recorder system according to the embodiment of the invention;

FIG. 8 shows the format of a drive recording data request message according to the embodiment of the invention;

FIG. 9 shows the format of a drive recording data request notification message according to the embodiment of the invention;

FIG. 10 illustrates how base station apparatus are selected according to the embodiment of the invention;

FIG. 11 is a process flowchart for a communication network according to the embodiment of the invention;

FIG. 12 shows the format of a drive recording data request response message according to the embodiment of the invention;

FIG. 13 is a process flowchart for a vehicle according to the embodiment of the invention;

FIG. 14 shows the format of a drive recording data request response tunnel message according to the embodiment of the invention;

FIG. 15 shows the format of a drive recording data transmission request message according to the embodiment of the invention;

FIG. 16 shows the format of a drive recording data transmission request tunnel message according to the embodiment of the invention;

FIG. 17 shows recording data according to the embodiment of the invention;

FIG. 18 is a process flowchart for a drive recorder recording center according to the embodiment of the invention; and

FIG. 19 shows the system configuration of each vehicle according to another embodiment of the invention.

### DESCRIPTION OF THE PREFERRED EMBODIMENTS

An embodiment of the present invention will be hereinafter described with reference to the drawings.

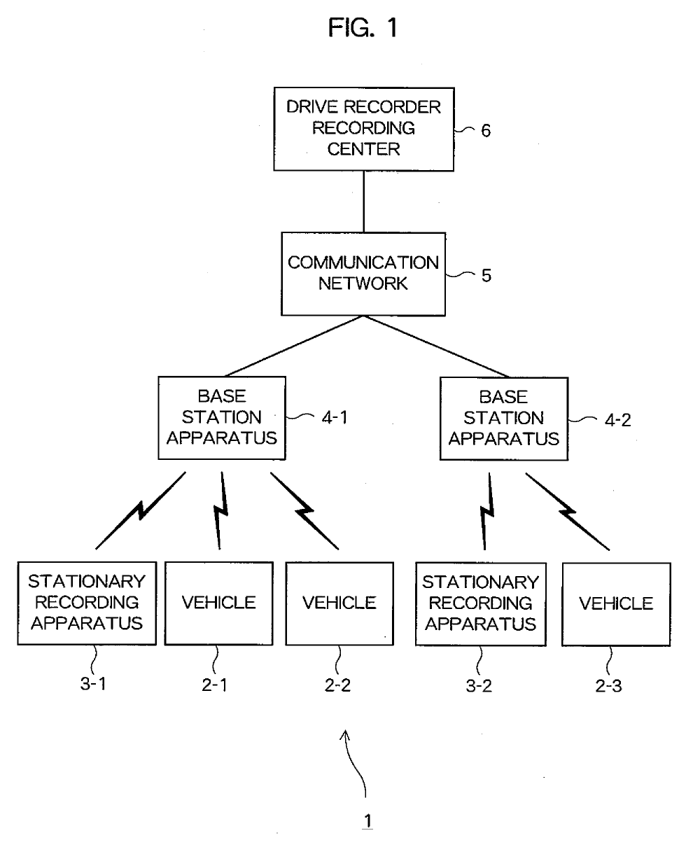

FIG. 1 shows the configuration of a recorder system 1 according to the embodiment. As shown in FIG. 1, the recorder system 1 includes plural vehicles 2, plural stationary recording apparatus 3, plural base station apparatus 4, a communication network 5, and a drive recorder recording center 6.

The recorder system 1 is a system for enabling the drive recorder recording center 6 to perform collection of objective recording data relating to an accident or incident in which a vehicle 2 has been involved.

Each vehicle 2 is a movable body such as a truck or a family car in which a vehicular recording apparatus and a mobile station apparatus of a mobile communication system are mounted. On the other hand, each stationary recording apparatus 3 is installed on or beside a road (e.g., attached to a utility pole or installed in a telephone booth) and incorporates a mobile station apparatus of the mobile communication system.

Each recording apparatus is equipped with information acquiring section such as a camera (described later) and successively stores recording data acquired by the information acquiring section and recording time points in such a manner that they are correlated with each other.

The base station apparatus 4 and part of the communication network 5 constitute the mobile communication system, which is a CDMA mobile communication system. As described later in detail, in CDMA mobile communication systems, each mobile station apparatus can easily acquire sync timing.

The other part of the communication network 5 may be a TCP/IP network including the Internet or, if the drive recorder recording center 6 directly accommodates the mobile communication system, a communication line relating to the direct accommodation.

Now assume that the vehicle 2-1, for example, has detected that itself has been rendered in a prescribed state (e.g., has had an accident). In such a case, the vehicle 2-1 acquires position data indicating its own position and time data indicating the time. Furthermore, the vehicle 2-1 selects other recording apparatus, that is, the recording apparatus of vehicles 2 and stationary recording apparatus 3, via a base station apparatus 4 and the communication network 5 and requests the selected recording apparatus to send recording data.

Each recording apparatus that has been requested to send recording data selects recording data to be sent among recording data thus far recorded and sends the selected recording data to a specified destination (e.g., the drive recorder recording center 6). If the specified destination is the drive recorder recording center 6, the drive recorder recording center 6 generates, on the basis of the recording data sent from the respective recording apparatus, objective recording data relating to the prescribed state in which the vehicle 2-1 has been rendered.

By generating objective recording data in the above-described manner, the recorder system 1 makes it possible to collect objective recording data of an accident or incident.

In the recorder system 1, the recording apparatus may be grouped. That is, the recorder system 1 may be such that plural recording apparatus form one group and processing of collecting objective recording data of an accident or incident is performed only on a group-by-group basis.

Specific processing performed by each apparatus of the recorder system 1 will be described below in detail.

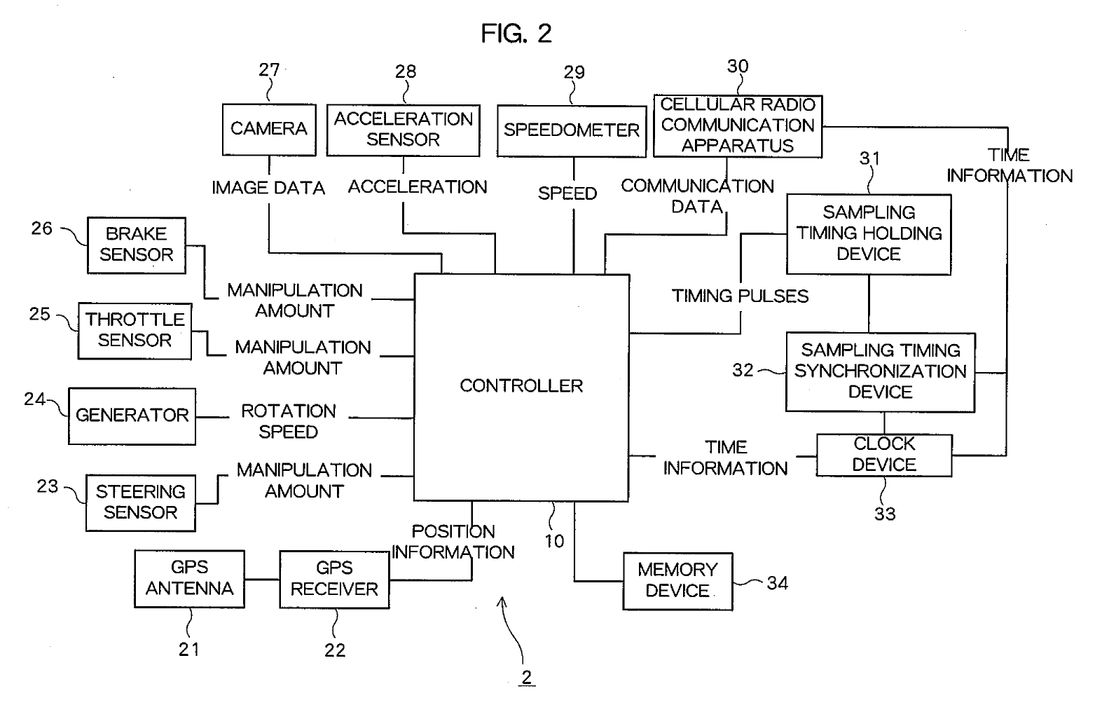

FIG. 2 shows the system configuration of each vehicle 2. As shown in FIG. 2, each vehicle 2 includes a controller 10, a GPS antenna 21, a GPS receiver 22, a steering sensor 23, a generator 24, a throttle sensor 25, a brake sensor 26, a camera 27, an acceleration sensor 28, a speedometer 29, a cellular radio communication apparatus 30, a sampling timing holding device 31, a sampling timing synchronization device 32, a clock device 33, and a memory device 34.

The controller 10 controls the individual sections of the vehicle 2 including the recording apparatus and performs recording data request processing, recording data request response processing, objective recording data generation processing, and other processing. Furthermore, the controller 10 detects that the vehicle 2 has been rendered in a prescribed state on the basis of data acquired by the following information acquiring section.

The GPS receiver 22, the steering sensor 23, the generator 24, the throttle sensor 25, the brake sensor 26, the camera 27, the acceleration sensor 28, and the speedometer 29 function as the information acquiring section.

More specifically, the GPS receiver 22 acquires position data indicating the position of the vehicle 2 on the basis of information coming from GPS satellites and received by the GPS antenna 21. The steering sensor 23, which consists of a gyro sensor and a compass, acquires direction data indicating the direction of the vehicle 2. The generator 24, which consists of an internal combustion engine and an electric motor of the vehicle 2, acquires drive state data indicating whether the generator 24 itself is in a driving state. The throttle sensor 25 acquires throttle data indicating whether the throttle is opened by the driver of the vehicle 2 and, if the throttle is opened, the degree of opening. The brake sensor 26 acquires brake data indicating whether braking is being performed by the driver and, if braking is being performed, the degree of braking. The camera 27, which is configured so as to be able to shoot, for example, the outside of the vehicle 2, acquires shooting data by performing shooting operations regularly. The acceleration sensor 28 and the speedometer 29 acquire acceleration data indicating the acceleration of the vehicle 2 and speed data indicating the speed of the vehicle 2, respectively, on the basis of the rotation speed of a wheel (not shown) of the vehicle 2.

The cellular radio communication apparatus 30 is a communication apparatus which functions as a mobile station apparatus of the above-mentioned mobile communication system. According to instructions from the controller 10, the cellular radio communication apparatus 30 performs processing of sending, to a base station apparatus 4, data that are output from the controller 10 and processing of receiving data transmitted from a base station apparatus 4 and outputting the received data to the controller 10. System time data indicating the system time of the mobile communication system is regularly included in data that are transmitted from each base station apparatus 4.

The sampling timing holding device 31 and the sampling timing synchronization device 32 perform sampling timing correction processing (described later) by acquiring the above-mentioned system time data. In performing this processing, the sampling timing holding device 31 and the sampling timing synchronization device 32 determine information acquisition timing of each information acquiring section and output it to the controller 10. The controller 10 acquires data from each information acquiring section on the basis of the received information acquisition timing.

The clock device 33, holds present time data. Furthermore, the clock device 33 acquires the above-mentioned system time data and performs time setting processing.

The memory device 34 operates as a work memory of the controller 10. The memory device 34 holds programs and parameters relating to various kinds of processing performed by the controller 10. Where the recording apparatus are grouped, the parameters include a group code indicating a group to which the recording apparatus incorporating the memory device 34 belongs.

Furthermore, the memory device 34 stores, as recording data, data acquired by the information acquiring section and present time data acquired by the clock device 33 in such a manner that they are correlated with each other. The memory device 34 is provided with a storage area having a ring-buffer-like structure, and stores recording data in the ring-buffer-like storage area in FIFO (first-in first-out) form.

Each kind of processing performed by each vehicle 2 will be described below.

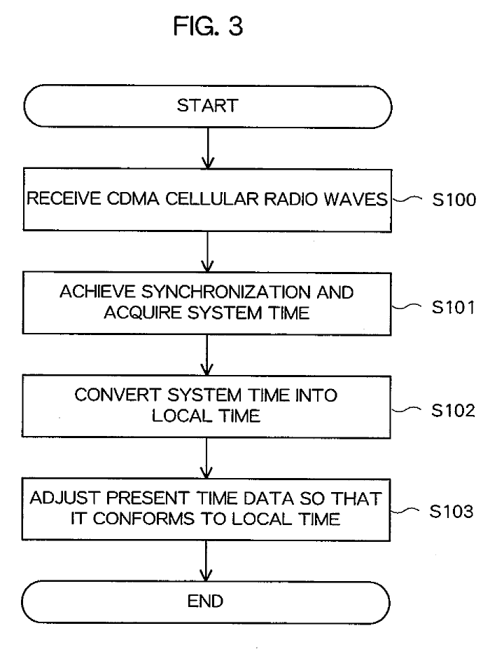

First, the time setting processing of the clock device 33 will be described with reference to a process flowchart of FIG. 3 to be performed in the vehicle 2. First, at step S100, the cellular radio communication apparatus 30 receives CDMA cellular radio waves from a base station apparatus 4. As described above, the CDMA cellular radio waves include system time data indicating the system time of the mobile communication system. At step S101, the cellular radio communication apparatus 30 acquires the system time data by achieving synchronization with the CDMA cellular radio waves and outputs the system time data to the clock device 33. At step S102, the clock device 33 converts the system time (world standard time) indicated by the received system time data into a local time (Japan standard time). At step S103, the clock device 33 adjusts the present time data held by itself so that it conforms to the local time. This is the time setting processing of the clock device 33.

Alternatively, the clock device 33 may perform time setting processing on the basis of system time data that is included in radio waves transmitted from GPS satellites and received by the GPS receiver 22. As a further alternative, the clock device 33 may perform time setting processing using both CDMA cellular radio waves and radio waves transmitted from GPS satellites.

The clock device 33 stores, in the memory device 34, via the controller 10, time information source information indicating whether the time of the clock device 33 itself has been set by using CDMA cellular radio waves, radio waves transmitted from GPS satellites, or both or time setting has not been performed yet.

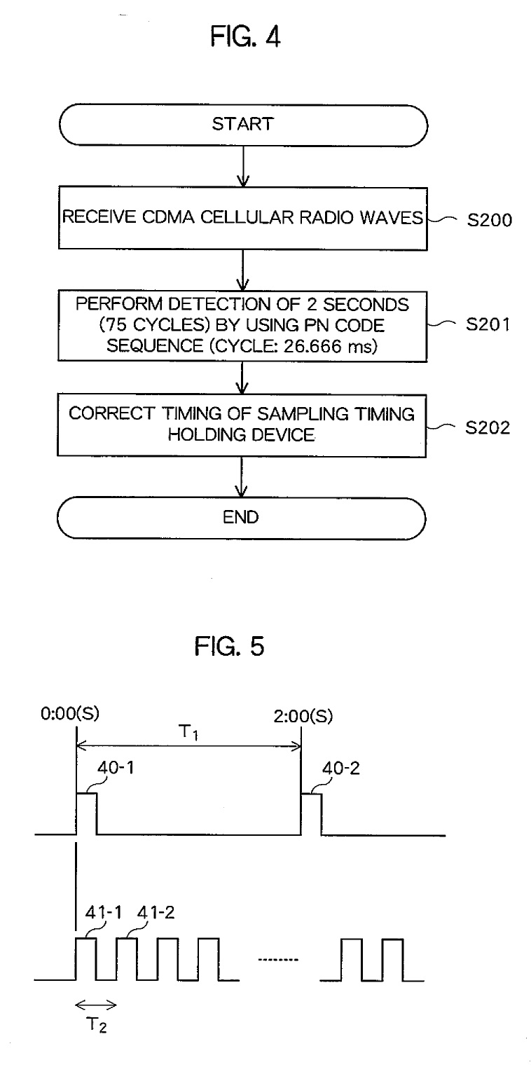

Next, sampling timing correction processing by which each vehicle 2 achieves synchronization with the mobile communication system will be described with reference to a process flow chart for each vehicle 2 shown in FIG. 4.

First, at step S200, the cellular radio communication apparatus 30 receives CDMA cellular radio waves transmitted from a base station apparatus 4. CDMA mobile communication systems employ a PN code (spread code) of 1.2288 Mchips/s. Also, one cycle of a PN code is 2¹⁵ chips. Therefore, the time corresponding to one cycle of a PN code is 2¹⁵/(1.2288×10⁶) (s) and a time T₁ corresponding to 75 cycles is 2 seconds. That is, the start position of a PN code coincides with a 0-second position every 2 seconds. The sampling timing synchronization device 32 detects a 0-second position utilizing this characteristic of the PN code. More specifically, at step S201, the sampling timing synchronization device 32 detects a PN code whose start position coincides with a 0-second position by monitoring a sequence of PN codes received by the cellular radio communication apparatus 30. In this manner, the sampling timing synchronization device 32 determines information acquisition timing of each information acquiring section.

At step S202, the sampling timing holding device 31 corrects the sampling timing held by itself on the basis of the 0-second position detected by the sampling timing synchronization device 32. The controller 10 acquires information acquisition timing on the basis of the sampling timing that is held by the sampling timing holding device 31 while being corrected in this manner.

The sampling timing correction processing performed by the sampling timing holding device 31 will be described below in more detail. Where information acquisition timing T₂ comes every 20 ms, for example, it is appropriate for the sampling timing holding device 31 to hold sampling timings whose cycle is 20 ms. In this case, the sampling timing holding device 31 corrects the sampling timing every 2 seconds. This processing will be described below with reference to FIG. 5.

FIG. 5 illustrates the sampling timing correction processing. As shown in FIG. 5, the sampling timing holding device 31 acquires timing 40 indicating a 0-second position every time the time T₁ (2 seconds) elapses. Among sampling timings 41 having the cycle T₂, sampling timing 41 closest to the timing 40 is adjusted so as to coincide with the timing 40.

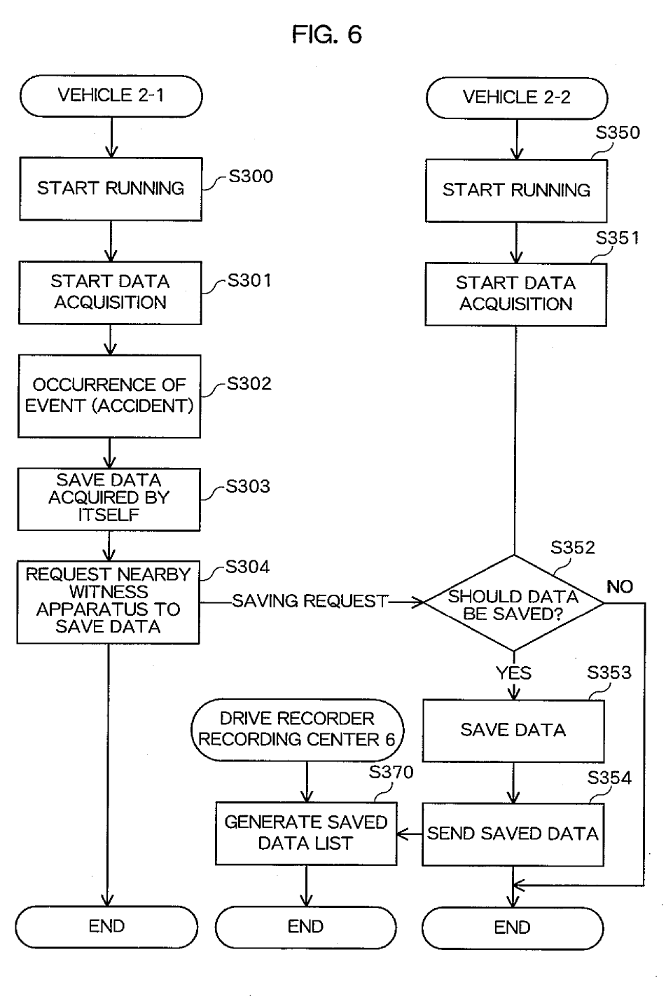

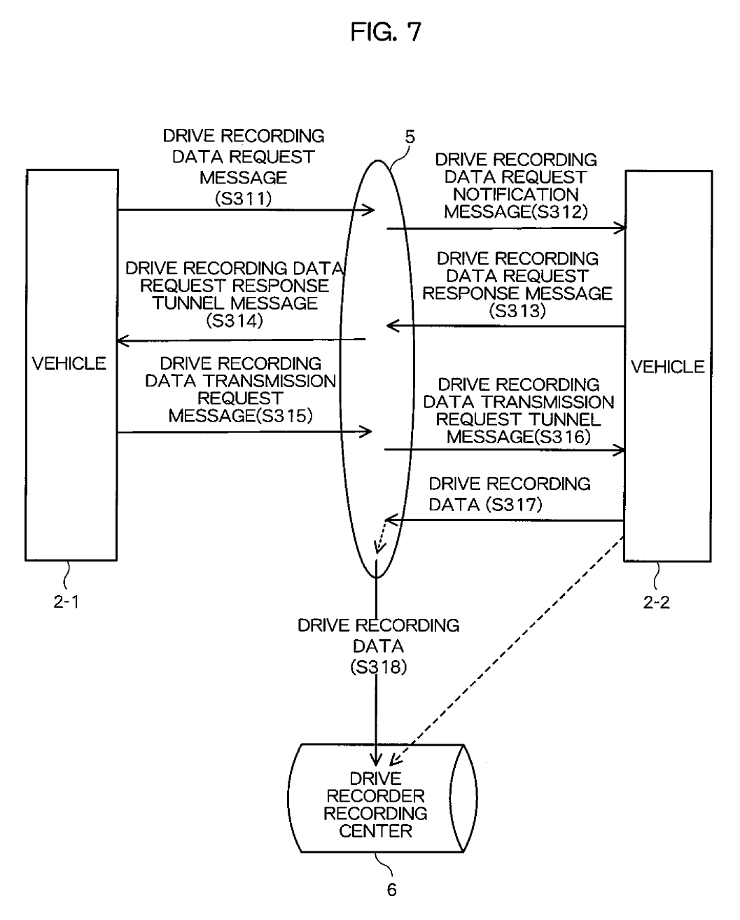

Next, recording data request processing and recording data request response processing which are performed when the vehicle 2-1 detects a prescribed state will be described with reference to a process flowchart for the vehicles 2-1 and 2-2 shown in FIG. 6 and a sequence diagram of the recorder system 1 shown in FIG. 7.

First, the vehicles 2-1 and 2-2 start running at steps 300 and 350, whereupon at step S301 or S351 each of the vehicles 2-1 and 2-2 starts data acquisition by each information acquiring section and recording of recording data in the ring-buffer-like storage area of the memory device 34.

If an event (prescribed state) such as an accident occurs with respect to the vehicle 2-1 at step S302, at step S303 the vehicle 2-1 saves so far recorded recording data in a storage area other than the ring-buffer-like storage area of the memory device 34. At step S304, the vehicle 2-1 requests recording apparatus located near the vehicle 2-1 to save the recording data stored therein.

More specifically, at step S311, the vehicle 2-1 generates a drive recording data request message and sends it to the communication network 5. At step S312, the communication network 5 generates a drive recording data request notification message and broadcasts it.

When receiving the saving request (recording data request notification message), the vehicle 2-2 judges at step S352 whether to save the recording data as requested. The details of this judgment step will be described later. If judging that the recording data should be saved, the vehicle 2-2 saves the recording data at step S353 and sends the saved recording data to the drive recorder recording center 6 at step S354. At step S370, the drive recorder recording center 6 stores the thus-received recording data by generating a saved data list including the received recording data.

After making a judgment at step S352, the vehicle 2-2 may communicate a result of the judgment to the vehicle 2-1 as a drive recording data request response message (5313 and S314). When receiving the drive recording data request response message, the vehicle 2-1 may send, to the vehicle 2-2, a drive recording data transmission request message indicating a specific saving request content (S315 and S316) if the judgment result is “the recording data should be saved.38 In response, the vehicle 2-2 may send, to the drive recorder recording center 6, recording data that conform to the saving request content of the drive recording data transmission request message (S317 and S318).

The recording data request processing and the recording data request response processing are performed in the above-described manner when the vehicle 2-1 detects a prescribed state. In the following, each of the above-described steps will be described in more detail with reference to the format of each message.

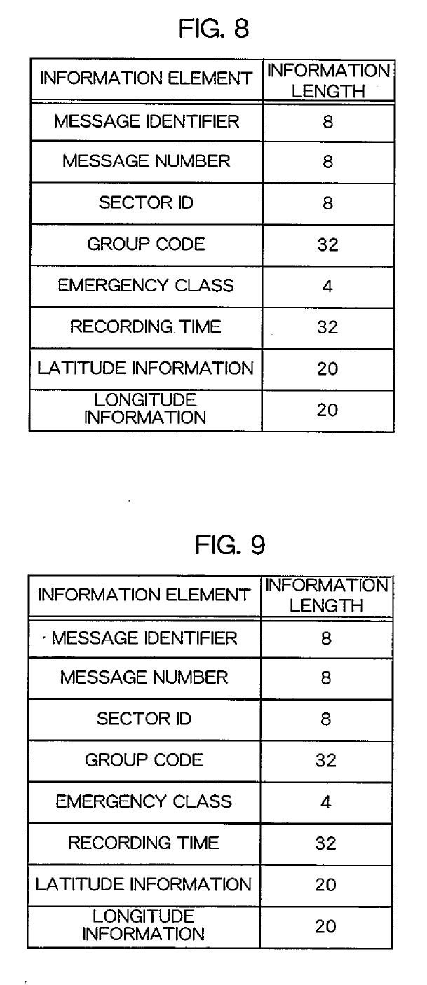

FIG. 8 shows the format of a drive recording data request message which is sent by the vehicle 2-1 when it detects a prescribed state. As shown in FIG. 8, the drive recording data request message consists of fields of “message identifier,” “message number,” “sector ID,” “group code,” “emergency class,” “recording time,” “latitude information,” and “longitude information.”

The “message identifier” is information indicating that this message is a drive recording data request message. The “message number” is a number that is assigned to the message when it is sent. This number is one of numbers that are sequentially assigned by the transmission-side communication apparatus to messages irrespective of their type and indicate their transmission order. The reception-side communication apparatus uses the message identifier to check whether this message stands at a legitimate place in an array of received messages.

The “sector ID” is information indicating an ID number of a base station apparatus 4 whose area is visited by the cellular radio communication apparatus 30 installed in the vehicle 2-1. The “group code” is stored in the memory device 34 of the vehicle 2-1 in the case where the recording apparatus are grouped.

The “emergency class” is information indicating the prescribed state detected by the vehicle 2-1. Examples of information to be set as the emergency class are “fatal emergency,” “non-serious emergency,” “airbag open”, “vehicle-vehicle accident,” “vehicle-human accident,” “vehicle-object accident,” “stuck,” and “technical trouble.” Which of these pieces of information should be set as the emergency class is judged by the controller 10 according to a prescribed algorithm on the basis of recording data acquired by the information acquiring section.

The “recording time” is present time data (prescribed state detection time data) that is acquired by the clock device 33 when the vehicle 2-1 detects a prescribed state. As described above, the present time data is synchronized with the system time of the mobile communication system. The “latitude information” and the “longitude information” are position data (prescribed state detection position data) that is acquired by the GPS receiver 22 when the recording apparatus detects a prescribed state.

When receiving a drive recording data request message having the above format, the communication network 5 generates a drive recording data request notification message and multicasts it. FIG. 9 shows the format of the drive recording data request notification message. As shown in FIG. 9, the fields of the drive recording data request notification message are the same as those of the drive recording data request message and the contents of the former are a copy of the contents of the latter. That is, the communication network 5 transfers the received drive recording data request message.

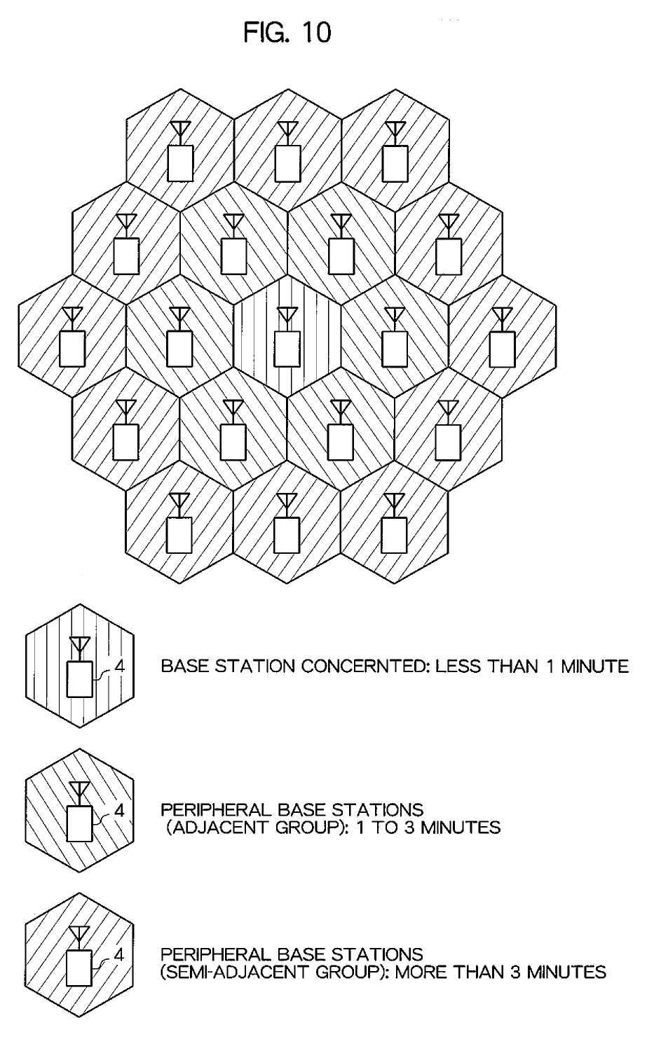

The communication network 5 selects, on the basis of the recording time contained in the drive recording data request message and present time data acquired by itself, base station apparatus 4 to which to multicast a drive recording data request notification message. A specific example is shown in FIG. 10.

FIG. 10 illustrates how the communication network 5 selects base station apparatus 4. In FIG. 10, the term “base station concerned” means a base station apparatus 4 whose area was visited by the vehicle 2-1 when it detected the prescribed state. The “sector ID” of the drive recording data request message corresponds to this “base station concerned”.

In general, in mobile communication systems, areas of base station apparatus are arranged in cellular form. In FIG. 4, the term “peripheral base stations (adjacent group)” means base station apparatus 4 whose areas are adjacent to the area of the base station concerned. The term “peripheral base stations (semi-adjacent group)” means base station apparatus 4 whose areas are adjacent to the areas of the peripheral base stations (adjacent group) excluding the base station concerned.

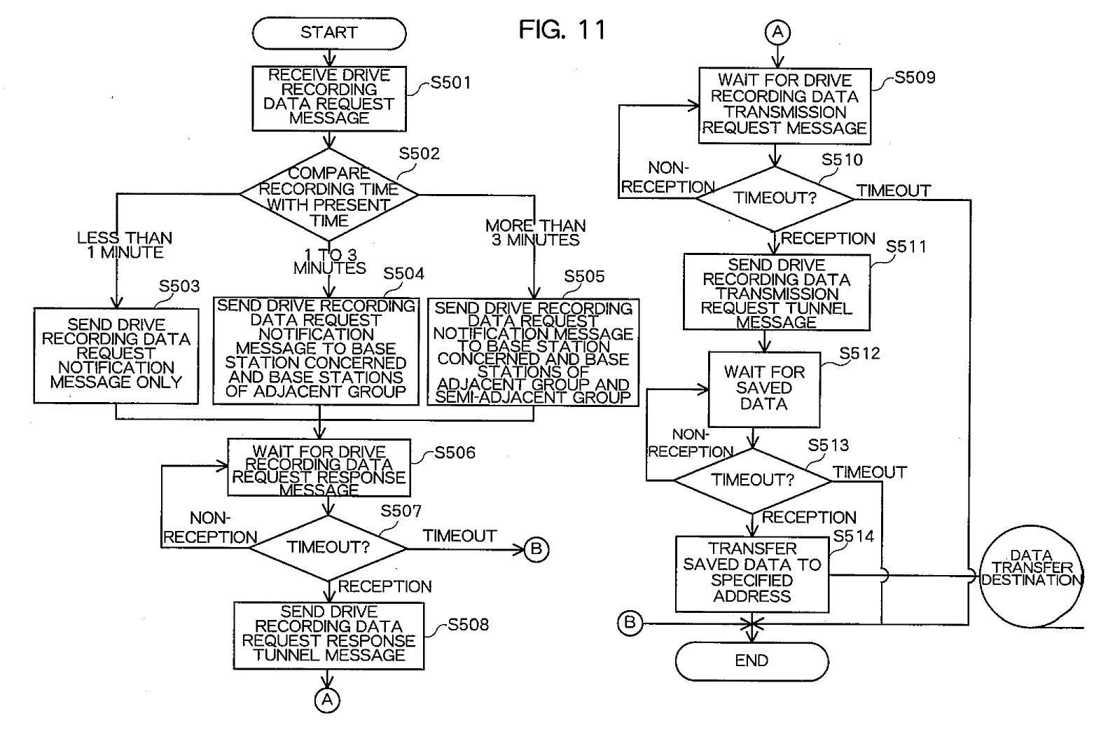

FIG. 11 is a process flowchart for the communication network 5. How the communication network 5 selects base station apparatus 4 will be described below in detail with reference to FIGS. 10 and 11.

At step S501, the communication network 5 receives a drive recording data request message. At step S502, the communication network 5 compares the recording time contained in the received drive recording data request message with present time data acquired by itself. If the difference is shorter than 1 minute, at step S503 the communication network 5 selects only the base station concerned and multicasts a drive recording data request notification message to it. If the difference is between 1 minute and 3 minutes, at step S504 the communication network 5 selects the base station concerned and the peripheral base stations (adjacent group) and multicasts a drive recording data request notification message to them. If the difference is longer than 3 minutes, at step S505 the communication network 5 selects the base station concerned, the peripheral base stations (adjacent group), and the peripheral base stations (semi-adjacent group) and multicasts a drive recording data request notification message to them. The communication network 5 selects base station apparatus 4 in this manner and the multicast area is expanded as time elapses.

Receiving the drive recording data request notification message, the vehicle 2-2 judges, on the basis of the information contained in the message, whether to save the recording data stored in the ring-buffer-like storage area of its own memory device 34. More specifically, the vehicle 2-2 may judge whether the group code stored in its own memory device 34 coincides with that contained in the drive recording data request notification message, and decide that the recording data stored in the ring-buffer-like storage area of its own memory device 34 should be saved only if they coincide with each other. Alternatively, the vehicle 2-2 may judge whether it was located near the site of the accident at the “recording time” on the basis of the position data stored in the ring-buffer-like storage area of its own memory device 34 as being correlated with the “recording time” contained in the drive recording data request notification message and the position data (“latitude information” and “longitude information”) contained in the drive recording data request notification message, and decide that the recording data stored in the ring-buffer-like storage area of its own memory device 34 should be saved only if the vehicle 2-2 judges that it was located near the site of the accident at the “recording time.”

The vehicle 2-2 judges in this manner whether to save the recording data in its own memory device 34. If the recording data should be saved, the vehicle 2-2 reads out the recording data from the ring-buffer-like storage area and stores the recording data in a storage area other than the ring-buffer-like storage area. This saving processing is continued for a period that is indicated by a recording time length (described later).

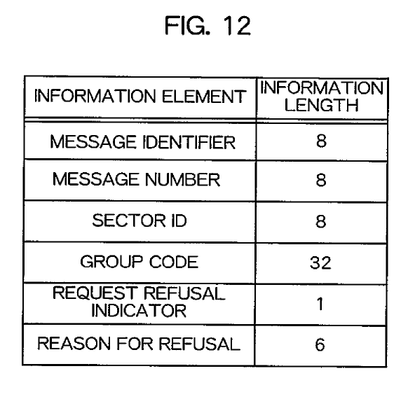

Then, the vehicle 2-2 sends a drive recording data request response message to the vehicle 2-1 via the communication network 5. FIG. 12 shows the format of the drive recording data request response message. As shown in FIG. 12, the drive recording data request response message consists of fields of “message identifier,” “message number,” “sector ID,” “group code,” “request refusal indicator,” and “reason for refusal.”

The “message identifier” is information indicating that this message is a drive recording data request response message. The “message number” is the same as described for the drive recording data request message.

The “sector ID” is information indicating an ID number of a base station apparatus 4 whose area is visited by the cellular radio communication apparatus 30 installed in the vehicle 2-2. The “group code” is one that is stored in the memory device 34 of the vehicle 2-2 in the case where the recording apparatus are grouped.

The “request refusal indicator” is information indicating the above judgment result as to whether to save the recording data. The “reason for refusal” is to state a reason for a decision that the recording data need not be saved, if such a decision is made.

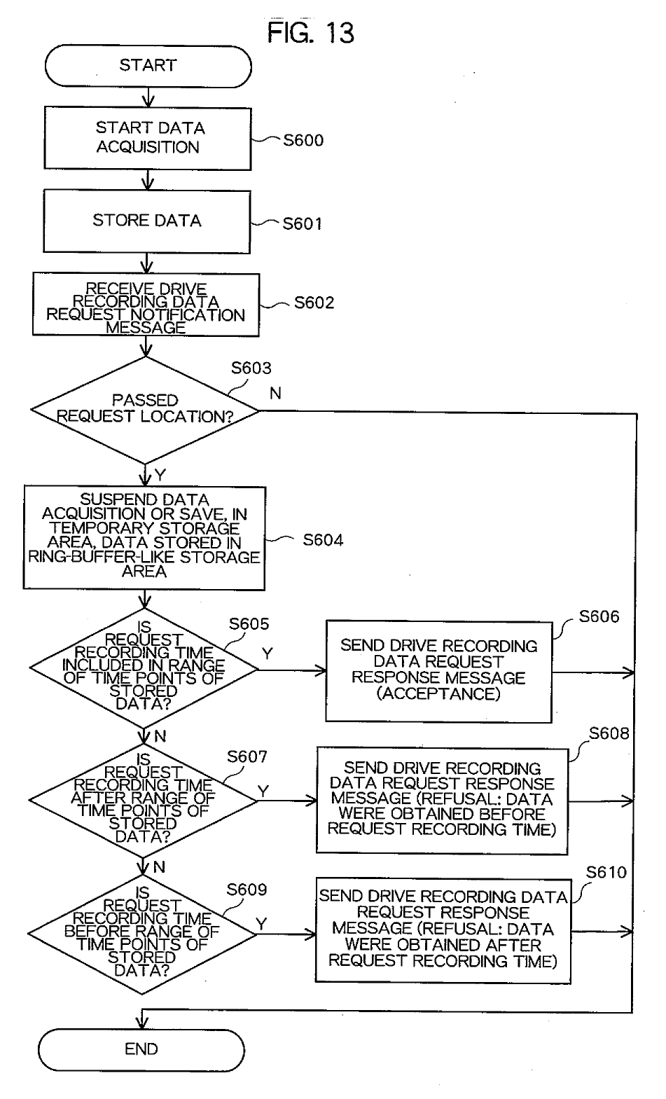

The above-described processing performed by the vehicle 2-2 will be described in more detail with reference to a process flowchart of FIG. 13.

FIG. 13 is a process flowchart for the vehicle 2-2. As shown in FIG. 13, at step S600, the vehicle 2-2 starts acquiring recording data when, for example, it starts running. At step S601, the vehicle 2-2 stores acquired recording data in the ring-buffer-like storage area. When receiving a drive recording data request notification message at step S602, at step S603 the vehicle 2-2 judges, on the basis of the position data contained in the drive recording data request notification message, whether it passed the request location of the message. More specifically, the vehicle 2-2 makes this judgment by reading the position data from the ring-buffer-like storage area.

If judging that it did not pass the request location, the vehicle 2-2 finishes the process without making any response to the drive recording data request notification message. On the other hand, if judging that it passed the request location, at step S604 the vehicle 2-2 suspends the acquisition of recording data to prevent recording data overwriting. Alternatively, the recording data in the ring-buffer-like storage area may be saved in a temporary storage area.

Then, the vehicle 2-2 compares the recording time points of the recording data (i.e., the time points of the stored data) with the “recording time” contained in the drive recording data request message, and performs the following processing depending on their relationship. Namely, if the “recording time” is included in the range of the time points of the stored data (S605: yes), at step S606 the vehicle 2-2 sends a drive recording data request response message whose “request refusal indicator” indicates that a decision has been made that the recording data should be saved. If the “recording time” is after the range of the time points of the stored data (S607: yes), at step S608 the vehicle 2-2 sends a drive recording data request response message whose “request refusal indicator” indicates that a decision has been made that the recording data need not be saved. In this case, the vehicle 2-2 states, in the “reason for refusal,” that all the recording data are data acquired before the “recording time.” If the “recording time” is before the range of the time points of the stored data (S609: yes), at step S610 the vehicle 2-2 sends a drive recording data request response message whose “request refusal indicator” indicates that a decision has been made that the recording data need not be saved. In this case, the vehicle 2-2 states, in the “reason for refusal,” that all the recording data are data acquired after the “recording time.”

In the above manner, the vehicle 2-2 performs the processing relating to the sending of a drive recording data request response message.

When receiving the drive recording data request response message, the communication network 5 generates a drive recording data request response tunnel message and sends it to the vehicle 2-1 which sent the corresponding drive recording data request message.

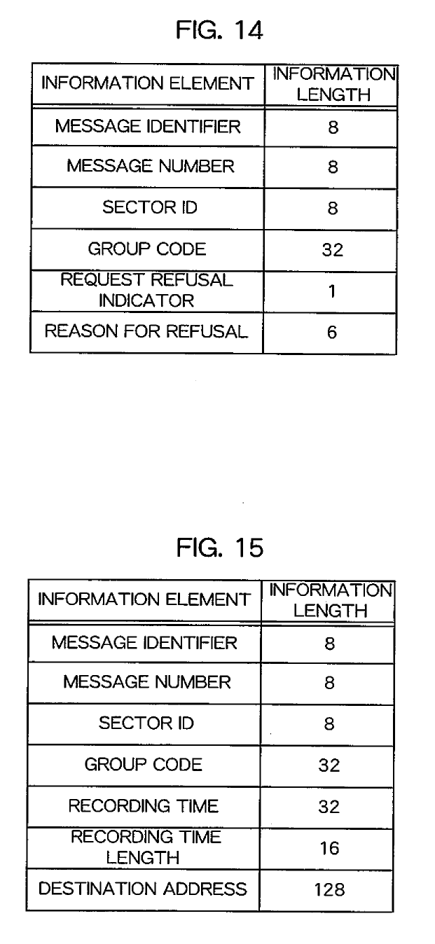

FIG. 14 shows the format of the drive recording data request response tunnel message. As shown in FIG. 14, the drive recording data request response tunnel message is a tunnel message whose contents are the same as the contents of the drive recording data request response message.

When receiving the drive recording data request response tunnel message, the vehicle 2-1 performs processing that depends on the “request refusal indicator” of the message. More specifically, if the “request refusal indicator” indicates that a decision has been made that the recording data should be saved, the vehicle 2-1 sends a drive recording data transmission request message to the vehicle 2-2 via the communication network 5. On the other hand, if the request refusal indicator indicates that a decision has been made that the recording data need not be saved, the vehicle 2-1 dose not perform any particular processing.

FIG. 15 shows the format of the drive recording data transmission request message. As shown in FIG. 15, the drive recording data transmission request message consists of fields of “message identifier,” “message number, ” sector ID, “group code,” “recording time,” “recording time length,” and “destination address.”

The “message identifier” is information indicating that this message is a drive recording data transmission request message. The “message number” is the same as described for the drive recording data request message.

The “sector ID” is information indicating the ID number of the base station apparatus 4 whose area is visited by the cellular radio communication apparatus 30 installed in the vehicle 2-1. The “group code” is stored in the memory device 34 of the vehicle 2-1 in the case where the recording apparatus are grouped.

The “recording time” is the present time data that was acquired by the clock device 33 when the vehicle 2-1 detected the prescribed state. The “recording time length” is information indicating a period (starting from the “recording time”) of recording data that should be saved in each recording apparatus in connection with the accident concerned.

The “destination address” is information indicating an apparatus (e.g., the drive recorder recording center 6) to which recording data saved by each recording apparatus should be sent. The vehicle 2-1 stores this information in own memory device 34. The vehicle 2-1 includes this information in a drive recording data transmission request message as a destination address when generating the drive recording data transmission request message.

When receiving the drive recording data transmission request message having the above format, the communication network 5 generates a drive recording data transmission request tunnel message and sends it to the vehicle 2-2 which sent the corresponding drive recording data request response message.

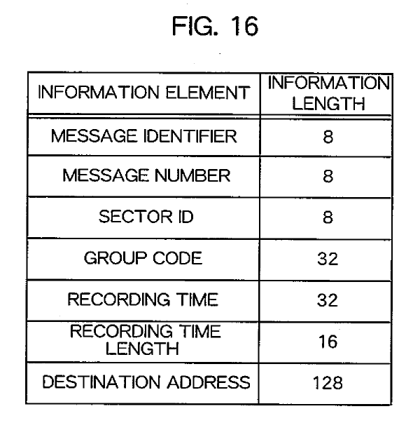

FIG. 16 shows the format of the drive recording data transmission request tunnel message. As shown in FIG. 16, the drive recording data transmission request tunnel message is a tunnel message whose contents are the same as the contents of the drive recording data transmission request message.

When receiving the drive recording data transmission request tunnel message, the vehicle 2-2 finishes, at the end of the period indicated by the “recording time length,” the saving of the recording data that was started in response to the drive recording data request notification message. The vehicle 2-2 sends the saved recording data to the drive recorder recording center 6.

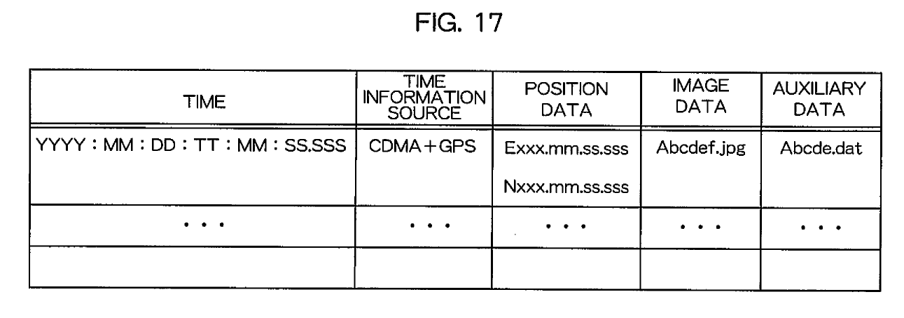

FIG. 17 shows an example of saved recording data (hereinafter referred to as “saved data”) that are sent from the vehicle 2-2 at this time. As shown in FIG. 17, for example, each piece of saved data includes a “time,” a “time information source,” “position data,” “image data,” and “auxiliary data.” By means of the drive recording data transmission request message, the vehicle 2-1 may inform the vehicle 2-2 what information should be included in the saved data. It goes without saying that other kinds of data acquired by the information acquiring section may also be included in the saved data.

The “time” is a time when each piece of recording data was recorded. This is measured by the clock device 33 provided in the vehicle 2-2. The “time information source” is the above-mentioned time information source information.

The “position data” is position data that was acquired by the vehicle 2-2 when each piece of recording data was recorded. The “image data” is shooting data that was taken by the camera 27 at the time point indicated by the “time.” If necessary, the “auxiliary data” contains auxiliary data such as information relating to the vehicle 2-2.

The above processing will be described below in more detail by returning to the process flowchart for the communication network 5 shown in FIG. 11.

As described above, when receiving the drive recording data request message sent from the vehicle 2-1, the communication network 5 selects base station apparatus and sends a drive recording data request notification message to each recording apparatus (S501-S505).

At step S506, the communication network 5 waits for a drive recording data request response message. If the drive recording data request response message is received within a prescribed period, at S508 the communication network 5 sends a drive recording data request response tunnel message. On the other hand, if it is not received within the prescribed period, the communication network 5 judges at step S507 that a timeout has occurred and finishes the process.

At step S509, the communication network 5 waits for a drive recording data transmission request message. If the drive recording data transmission request message is received within a prescribed period, at S511 the communication network 5 sends a drive recording data transmission request tunnel message. On the other hand, if it is not received within the prescribed period, the communication network 5 judges at step S510 that a timeout has occurred and finishes the process.

At step S512, the communication network 5 waits for saved data. If saved data is received within a prescribed period, at S514 the communication network 5 transfers the saved data to a specified address. On the other hand, if saved data is not received within the prescribed period, the communication network 5 judges at step S513 that a timeout has occurred and finishes the process.

In the above manner, the communication network 5 performs the processing of relaying a signal between each recording apparatus and the drive recorder recording center 6.

Next, a description will be made of processing in which an information processing apparatus provided in the drive recorder recording center 6 generates objective recording data on the basis of saved data transmitted from vehicles 2.

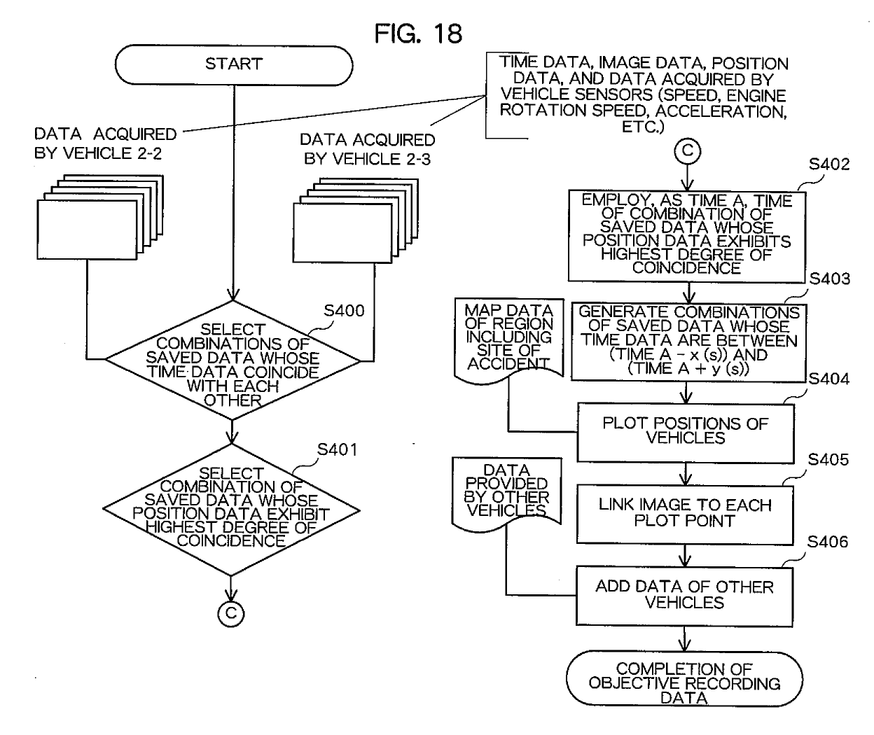

FIG. 18 is a flowchart of an objective recording data generation process which is executed in the drive recorder recording center 6. In FIG. 18, it is assumed that the drive recorder recording center 6 has received saved data from the vehicles 2-2 and 2-3.

First, at step S400, the drive recorder recording center 6 selects saved data whose “time” data coincide with each other from the saved data transmitted from the vehicles 2-2 and 2-3 and produces several combinations of saved data. In doing so, based on the time information source information contained in the saved data, the drive recorder recording center 6 may refrain from employing saved data whose time accuracy is judged insufficient (i.e., the time information source is not a prescribed one).

At step S401, the drive recorder recording center 6 calculates the degree of coincidence between the position data of each combination of saved data and selects a combination exhibiting a highest degree of coincidence (i.e., the distance is within a prescribed value). At step S402, the drive recorder recording center 6 acquires the “time” from the selected combination of saved data and stores it as time A.

At step S403, the drive recorder recording center 6 generates combinations of saved data whose time data are between (time A−x (s)) and (time A+y (s)) where x and y are prescribed values. At step S404, the drive recorder recording center 6 plots, on a map, the position data contained in the generated combinations of saved data. At step S405, the drive recorder recording center 6 links the shooting data (image files) to the respective plot points. A specific example is such that the drive recorder recording center 6 makes necessary settings so that an image file is displayed when a plot point is clicked with a mouse.

At step S406, the drive recorder recording center 6 plots position data of other vehicles on the map to produce objective recording data. The drive recorder recording center 6 thus generates the objective recording data.

In the above-described manner, the recorder system 1 collects objective recording data of an accident or incident. That is, when an image transmission requesting apparatus (i.e., the recording apparatus of the vehicle 2-1) has detected that a certain movable body (i.e., vehicle 2-1) has been rendered in a prescribed state (e.g., has had an accident), it can cause other recording apparatus (e.g., vehicle 2-2) to send image information of images taken at the time of occurrence of the accident. This makes it possible to cause recording apparatus other than the recording apparatus installed in the movable body (vehicle 2-1) that has had the accident to send image information of images taken at the time of occurrence of the accident.

When it is detected that a movable body (vehicle 2-1) has been rendered in a prescribed state, image information acquired at the time of the detection of the prescribed state can be saved in an image transmission requesting apparatus (the recording apparatus of the vehicle 2-1) or another apparatus (e.g., drive recorder recording center 6).

Further, a recording apparatus (vehicle 2-2) can select image information acquired when a recording apparatus (vehicle 2-1) which sent a transmission request message detected a prescribed state from pieces of image information that were acquired regularly.

Still further, the communication network 5 can determine, depending on the elapsed time from the detection of a prescribed state, a range where recording apparatus to which to send a transmission request message are located.

The invention is not limited to the above embodiment. For example, although the above embodiment is directed to the case where the recording apparatus installed in each vehicle 2 saves recording data, it goes without saying that each stationary recording apparatus 3 may save recording data and send the saved recording data to the drive recorder recording center 6. Although in the above embodiment the communication network 5 selects base station apparatus 4, the vehicle 2-1 that requests sending of recording data may select the base station apparatus.

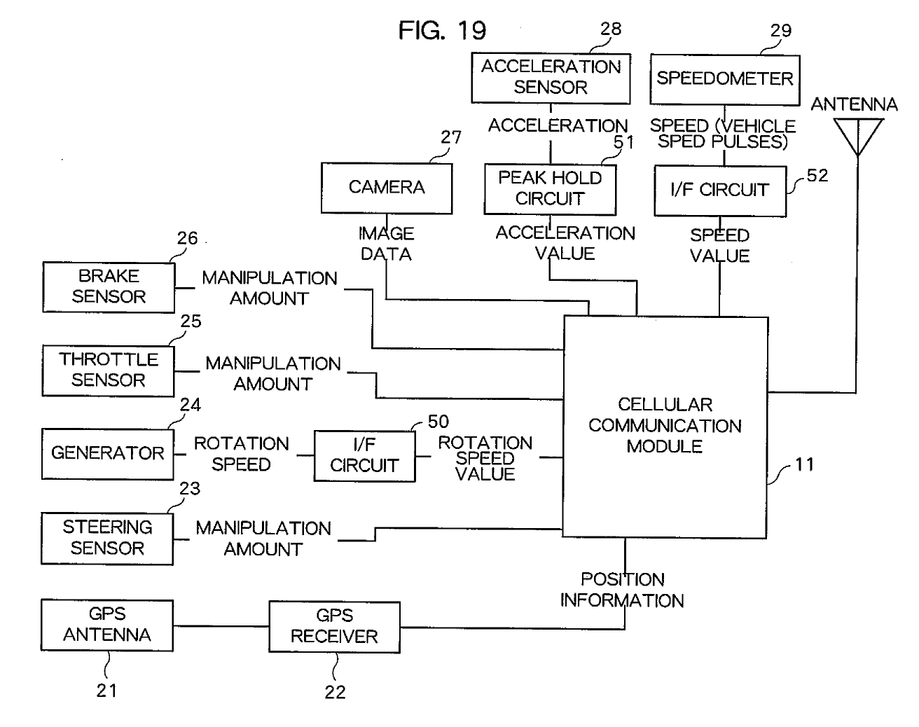

Furthermore, the system configuration of each vehicle 2 is not limited to the one shown in FIG. 2 and, for example, a configuration shown in FIG. 19 can also be employed. In the configuration of FIG. 19, the controller 10, the cellular radio communication apparatus 30, the sampling timing holding device 31, the sampling timing synchronization device 32, the clock device 33, and the memory device 34 are combined into a single cellular communication module 11. With this configuration, a recording apparatus according to the invention can be sold as a module product.

It is preferable that an interface circuit 50 be inserted between the generator 24 and the cellular communication module 11, a peak hold circuit 51 be inserted between the acceleration sensor 28 and the cellular communication module 11, and an interface circuit 52 be inserted between the speedometer 29 and the cellular communication module 11. The circuits 50-52 are circuits for converting data acquired by the associated information acquiring section into data that can be handled by the cellular communication module 11. The peak hold circuit 51 allows the cellular communication module 11 to acquire data indicating short-time acceleration by temporarily storing a peak in an output signal of the acceleration sensor 28.

While there have been described what are at present considered to be preferred embodiments of the invention, it will be understood that various modifications may be made thereto, and it is intended that the appended claims cover all such modifications as fall within the true spirit and scope of the invention.

Further, the disclosure of Japanese Patent Application No. 2005-190630 filed on Jun. 29, 2005, including the specification, claims, drawings, and abstract, is incorporated herein by reference in its entirety.

What is claimed is:

1. An image requesting apparatus, comprising:
state detecting section for detecting a state of a movable body;
position data acquiring section for acquiring position data indicating a position where the movable body is located when the state detecting section detects a prescribed state;
time data acquiring section for acquiring time data indicating a time when the state detecting section detects the prescribed state;
request message sending section for sending a request message that contains the position data and the time data to a recording apparatus.

2. The image requesting apparatus according to claim 1, wherein the request message includes the message to save a recording data based on the position data and the time data.

3. A recorder system comprising plural recording apparatus provided with shooting section and an image requesting apparatus, wherein:
the image requesting apparatus comprises:
state detecting section for detecting a state of a movable body;
position data acquiring section for acquiring position data indicating a position where the movable body is located when the state detecting section detects a prescribed state;
time data acquiring section for acquiring time data indicating a time when the state detecting section detects the prescribed state; and
request message sending section for sending a request message that contains the position data and the time data to a recording apparatus;
each of the plural recording apparatus comprises:
receiving section for receiving the request message sent from the image requesting apparatus; and
saving section for saving image information that was taken by the shooting section when the request message is received by the receiving section.

4. The recorder system according to claim 3, wherein the request message includes message to save the image information based on the position data and the time data.

5. The recorder system according to claim 4, wherein each of the recording apparatus further comprises image information regularly acquiring section for regularly acquiring image information taken by the shooting section; and
wherein the saving section selects, on the basis of the position data and the time data included in the request message, at least one piece of image information from pieces of image information that were taken regularly by the image information regularly acquiring section and saves the selected at least one piece of image information, when the request message is received by the receiving section.
